(19) United States
(12) Patent Application Publication
(10) Pub. No.: US 2007/0051870 A1
(43) Pub. Date: Mar. 8, 2007

(54) Optical pickup apparatus and information recording and reproducing apparatus

(75) Inventor: Kohji Miyake, Higashihiroshima-shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 11/518,022

(22) Filed: Sep. 8, 2006

(30) Foreign Application Priority Data
Sep. 8, 2005 (JP) JP2005-261192

(51) Int. Cl. G02B 27/40

(52) U.S. Cl. 250/201.5

(57) ABSTRACT

An optical pickup apparatus and an information recording and reproducing apparatus are provided. When a focused state is obtained on a first light receiving portion corresponding to a first laser beam, a relative position of a sensor lens to the first light receiving portion is regulated so that a first FES becomes zero, and light receiving regions of a second light receiving portion that receives light reflected from an optical recording medium corresponding to a second laser beam are defined so that a second FES outputted from the second light receiving portion becomes zero. Consequently, when the first FES outputted from the first light receiving portion becomes zero, the second FES outputted from the second light receiving portion can also become zero. Consequently, it is possible to prevent occurrence of a focus offset with respect to both one oscillation wavelength and the other oscillation wavelength.

### BACKGROUND OF THE INVENTION

1. Field of the Invention

The present invention relates to an optical pickup apparatus and an information recording and reproducing apparatus that are suitable for use in at least one of processing of reproducing information of a plurality of optical recording mediums of different standards and processing of recording information on an optical recording medium.

2. Description of the Related Art

In a related art optical pickup apparatus, a first light emitting portion that emits a first laser beam and a second light emitting portion that emits a second laser beam having an oscillation wavelength different from that of the first laser beam are provided on one surface of a semiconductor substrate, respectively. Each of the first laser beam emitted from the first light emitting portion and the second laser beam emitted from the second light emitting portion is reflected from an optical recording medium, and thereafter, passes through a sensor lens for guiding the laser beams to a light receiving device, and is condensed on the light receiving device. The first laser beam is received by a first light receiving portion that is a component of the light receiving device, and the second laser beam is received by a second light receiving portion that is a component of the light receiving device, and the laser beams are converted into electric signals corresponding to intensities of the laser beams. A cylindrical face is formed on one surface portion of the sensor lens. The related art optical pickup apparatus is configured so as to detect a focus error signal by the astigmatic method by using astigmatism generated by the cylindrical face of the sensor lens (refer to Japanese Unexamined Patent Publication JP-A 2003-272218, for example).

FIGS. 11A and 11B are views for illustrating just-focus positions for the first and second laser beams in the related art optical pickup apparatus. FIG. 11A is a view for illustrating a first just-focus position FA for the first laser beam, and FIG. 11B is a view for illustrating a second just-focus position FB for the second laser beam. In FIGS. 11A and 11B, in order to make it easy to understand, a collimation lens 1 and a sensor lens 2 as components of the related art optical pickup apparatus are illustrated. FIG. 12 is a view illustrating a shape of a first light receiving portion 3 as a component of the related art optical pickup apparatus and a shape of a condensation spot BS1 of the first laser beam on the first light receiving portion 3. FIG. 13 is a view illustrating a shape of a second light receiving portion 4 as a component of the related art optical pickup apparatus and a shape of a condensation spot BS 2 of the second laser beam on the second light receiving portion 4.

The first light receiving portion 3 has a square shape when seen from a side where light enters. The first light receiving portion is divided in four by two dividing lines 3e and 3f, thereby having four light receiving regions 3a, 3b, 3c and 3d having square shapes. The second light receiving portion 4 has a square shape when seen from a side where light enters. The second light receiving portion is divided in four by two dividing lines 4E and 4F, thereby having four light receiving regions 4A, 4B, 4C and 4D having square shapes. It is desirable that an interval between optical axes of the two laser beams is as small as possible, and it is desirable in practical use that the interval is approximately 100 μm. Accordingly, there is a need to dispose the first and second light receiving portions 3 and 4 so that a center distance therebetween becomes as small as approximately 100 μm, and it is desirable to form on one semiconductor substrate.

In the related art optical pickup apparatus, the first and second laser beams reflected from the optical recording medium, which is not illustrated in the drawing, pass through the collimation lens 1 and the sensor lens 2, and are condensed on the first and second light receiving portions 3 and 4. There is a difference in astigmatism generated by the cylindrical face formed on the one surface portion of the sensor lens 2 between the two laser beams.

Accordingly, the just-focus position FA for the first laser beam, which is specifically a position in an optical axis direction of the first light receiving portion 3 when the first laser beam reflected from the optical recording medium is received by the first light receiving portion 3 and the shape of the condensation spot BS1 of the first laser beam becomes a circular shape, namely, a circle of least confusion (occasionally referred to as “first just-focus position” hereinafter), does not coincide with the just-focus position FB for the second laser beam, which is specifically a position in an optical axis direction of the second light receiving portion 4 when the second laser beam reflected from the optical recording medium is received by the second light receiving portion 4 and the shape of the condensation spot BS2 of the second laser beam becomes a circular shape, namely, a circle of least confusion (occasionally referred to as “second just-focus position” hereinafter).

The first just-focus position FA relatively deviates from the second just-focus position FB, and a length difference ΔL is made between the first just-focus position FA and the second just-focus position FB. In the related art optical pickup apparatus, a two-wavelength semiconductor laser device having the first and second light emitting portions that are formed on the one surface of the semiconductor substrate and that emit laser beams of different oscillation wavelengths is used as a light source, so that it is impossible to regulate positions of the first and second light emitting portions, respectively, to regulate the length difference ΔL.

In the case of regulating a position of the light receiving device including the first and second light receiving portions 3 and 4 so that the positions in the axial directions of the first and second light receiving portions 3 and 4 coincide with the first just-focus position FA, the shape of the condensation spot BS1 when the first laser beam enters the first light receiving portion 3 of the light receiving device becomes a circular shape as illustrated in FIG. 12, and the light amounts of the first laser beam entering the respective light receiving regions 3a to 3d of the first light receiving portion 3 become uniform. However, the shape of the condensation spot BS2 when the second laser beam enters the second light receiving portion 4 of the light receiving device becomes an elliptic shape as illustrated in FIG. 13, and the light amounts of the second laser beam entering the respective light receiving regions 4A to 4D of the second light receiving portion 4 do not become uniform.

A focus error signal in the first light receiving portion 3 (occasionally referred to as “first FES” hereinafter) and a focus error signal in the second light receiving portion 4 (occasionally referred to as “second FES” hereinafter) by the astigmatic method are detected based on the following expressions (1) and (2), where signals outputted from the light receiving regions 3a, 3b, 3c and 3d of the first light receiving portion 3 are V3a, V3b, V3c and V3d, respectively, and signals outputted from the light receiving regions 4A, 4B, 4C and 4D of the second light receiving portion 4 are V4A, V4B, V4C and V4D, respectively:
First FES=(V3a+V3c)−(V3b+V3d) (1)
Second FES=(V4A+V4C)−(V4B+V4D) (2)

In the aforementioned related art, in a case where the position of the light receiving device is regulated so that the first laser beam emitted from the light source is focused on the optical recording medium and the first FES becomes zero, that is, the shape of the condensation spot BS1 when the first laser beam enters the first light receiving portion 3 of the light receiving device becomes a circular shape, the shape of the condensation spot BS2 when the second laser beam enters the second light receiving portion 4 of the light receiving device becomes an elliptic shape, and the second FES does not become zero. Consequently, even when the second laser beam emitted from the light source is focused on the optical recording medium, the light reflected from the optical recording medium is not focused on the second light receiving portion 4 when entering the second light receiving portion 4. That is to say, a focus offset occurs with respect to the second laser beam.

A tolerance limit of a focus offset in an optical disk reproducing apparatus is defined with ±, for example, as ±25%. The focus offset tends to lean toward either a plus side or a minus side. In a case where the focus offset thus leans toward either the plus side or the minus side, there arises a problem that a regulation margin of the focus offset becomes small. Moreover, in a case where the amount of the focus offset is too large, there arises a problem that it is impossible to accurately reproduce information recorded on an optical recording medium and record information on an optical recording medium.

### SUMMARY OF THE INVENTION

An object of the invention is to provide an optical pickup apparatus and an information recording and reproducing apparatus that are capable of accurately reproducing information from an optical recording medium and recording information on an optical recording medium.

The invention provides an optical pickup apparatus that detects a focus error signal by an astigmatic method, the optical pickup apparatus comprising:

a light source for emitting laser beams of a plurality of oscillation wavelengths;

a light receiving device having a plurality of light receiving portions that receive laser beams of a plurality of oscillation wavelengths emitted from the light source, the light receiving portions each having a plurality of light receiving regions, and being capable of outputting a focus error signal based on the laser beams received by the plurality of light receiving regions; and

an optical component placed midway in an optical path between the light source and the light receiving device, for generating an astigmatism,

wherein a relative position of the optical component is regulated so that a focused state is obtained on one light receiving portion corresponding to a laser beam of one oscillation wavelength among the light receiving portions corresponding to the laser beams of the plurality of oscillation wavelengths, and

the light receiving regions of each of the other light receiving portions are defined so that the focus error signals outputted from the other light receiving portions corresponding to the other laser beams of the other oscillation wavelengths become zero.

According to the invention, a light receiving device has a plurality of light receiving portions that receive laser beams of oscillation wavelengths emitted from a light source, and each of the light receiving portions has a plurality of light receiving regions. Each of the light receiving portions of the light receiving device is capable of outputting a focus error signal by the astigmatic method based on the laser beam received by the plurality of light receiving regions. An optical component is placed midway in an optical path between the light source and the light receiving device, and generates an astigmatism. A relative position of the optical component to one light receiving portion corresponding to a laser beam of one oscillation wavelength emitted from the light source is regulated so that a focused state is obtained on the one light receiving portion. Then, the light receiving regions of each of the other light receiving portions are defined so that the focus error signals outputted from the other light receiving portions corresponding to the other laser beams of the other oscillation wavelengths become zero.

Consequently, when a focus error signal outputted from the one light receiving portion that receives light reflected from one optical recording medium corresponding to the laser beam of the one oscillation wavelength becomes zero, the focus error signals outputted from the other light receiving portions that receive the light reflected from the other optical recording mediums corresponding to the laser beam of the other oscillation wavelengths can also become zero. Therefore, it is possible to prevent occurrence of a focus offset with respect to both the one oscillation wavelength and the other oscillation wavelengths.

Further, by preventing occurrence of the focus offset, it is possible, in order to form a focal point of a beam spot of the laser beam of each of the oscillation wavelengths emitted from the light source on an information recording surface of the optical recording medium, to stably execute focus servo control of regulating the relative position of the objective lens to the optical recording medium and controlling a focus position of the beam spot. Therefore, it is possible to accurately execute processing of reproducing information recorded on an optical recording medium and processing of recording information on an optical recording medium. Consequently, it is possible to increase the reliability of an optical pickup apparatus, and it is also possible to increase the yield of an optical pickup apparatus.

Further, in the invention, it is preferable that the plurality of light receiving regions of the other light receiving portions are formed by dividing the other light receiving portions by a first dividing line and a second dividing line, and at least one of angles formed by the first dividing line and the second dividing line is defined so as to become an acute angle or an obtuse angle.

According to the invention, the plurality of light receiving regions of each of the light receiving portions corresponding to the laser beams of the other oscillation wavelengths are formed by dividing the other light receiving portions by a first dividing line and a second dividing line, and at least one of angles formed by the first dividing line and the second dividing line is defined so as to become an acute angle or an obtuse angle. Consequently, when the focus error signal outputted from the one light receiving portion that receives the laser beam of the one oscillation wavelength becomes zero, the focus error signals outputted from the other light receiving portions corresponding to the laser beams of the other oscillation wavelengths can also become zero. Therefore, it is possible to prevent occurrence of a focus offset with respect to both the one oscillation wavelength and the other oscillation wavelengths.

By preventing occurrence of the focus offset, it is possible to execute the focus servo control with stability. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Furthermore, the invention provides an optical pickup apparatus that detects a focus error signal by an astigmatic method, the optical pickup apparatus comprising:

a light source for emitting laser beams of a plurality of oscillation wavelengths;

a light receiving device having a plurality of light receiving portions that receive laser beams of a plurality of oscillation wavelengths emitted from the light source, the light receiving portions each being capable of outputting a focus error signal based on the received laser beam; and

an optical component placed midway in an optical path between the light source and the light receiving device, for generating an astigmatism,

wherein relative positions of the plurality of light receiving portions to the optical component are defined so that when a focus error signal outputted from one light receiving portion corresponding to a laser beam of one oscillation wavelength becomes zero, focus error signals outputted from the other light receiving portions corresponding to laser beams of the other oscillation wavelengths become zero.

According to the invention, a light receiving device has a plurality of light receiving portions that receive laser beams of different oscillation wavelengths emitted from a light source, and each of the plurality of light receiving portions is capable of outputting a focus error signal by the astigmatic method based on the received laser beam. Relative positions of the plurality of light receiving portions to the optical component are defined so that when a focus error signal outputted from one light receiving portion corresponding to a laser beam of one oscillation wavelength becomes zero, focus error signals outputted from the other light receiving portions corresponding to laser beams of the other oscillation wavelengths become zero.

Consequently, when the focus error signal outputted from the one light receiving portion corresponding to the laser beam of the one oscillation wavelength becomes zero, the focus error signals outputted from the other light receiving portions corresponding to the laser beams of the other oscillation wavelengths can also become zero. Therefore, it is possible to prevent occurrence of a focus offset with respect to both the one oscillation wavelength and the other oscillation wavelengths. By preventing occurrence of the focus offset, it is possible, in order to form a focal point of a beam spot of the laser beam of each of the oscillation wavelengths emitted from the light source on an information recording surface of an optical recording medium, to stably execute focus servo control of regulating the relative position of the objective lens to the optical recording medium and controlling a focus position of the beam spot.

Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, in the invention, it is preferable that the optical component is placed midway in an optical path that guides light reflected from an optical recording medium, to the light receiving device, and

the one light receiving portion and the other light receiving portions are placed so that a distance between the optical component and the one light receiving portion becomes shorter than distances between the optical component and the other light receiving portions, in case where the one oscillation wavelength is shorter than the other oscillation wavelengths.

According to the invention, the optical component is placed midway in an optical path that guides light reflected from an optical recording medium, to the light receiving device. The one light receiving portion and the other light receiving portions are placed so that a distance between the optical component and the one light receiving portion becomes shorter than distances between the optical component and the other light receiving portions, in case where the one oscillation wavelength is shorter than the other oscillation wavelengths. In other words, the one light receiving portion and the other light receiving portions are placed so that the distances between the optical component and the other light receiving portions becomes longer than the distance between the optical component and the one light receiving portion, in case where the other oscillation wavelengths are longer than the one oscillation wavelength.

Consequently, when the focus error signal outputted from the one light receiving portion becomes zero, the focus error signals outputted from the other light receiving portions can also become zero. Therefore, it is possible to prevent occurrence of a focus offset with respect to both the one oscillation wavelength and the other oscillation wavelengths. By preventing occurrence of the focus offset, it is possible to execute the focus servo control with stability. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, the invention provides an optical pickup apparatus that detects a focus error signal by an astigmatic method, the optical pickup apparatus comprising:

a light source for emitting laser beams of a plurality of oscillation wavelengths;

a light receiving device having a plurality of light receiving portions that receive laser beams of a plurality of oscillation wavelengths emitted from the light source, the light receiving portions each being capable of outputting a focus error signal based on the received laser beam; and

an optical component placed midway in an optical path between the light source and the light receiving device, for generating an astigmatism,

wherein the light receiving device is provided with a correcting section for correcting astigmatisms which are generated by the optical component and different in accordance with the oscillation wavelengths, so that the astigmatisms coincide with each other.

According to the invention, a light receiving device has a plurality of light receiving portions that receive laser beams of different oscillation wavelengths emitted from a light source, and the plurality of light receiving portions are each capable of outputting a focus error signal by the astigmatic method based on the received laser beam. An optical component that generates astigmatism is placed midway in an optical path between the light source and the light receiving device. The light receiving device is provided with a correcting section for correcting astigmatisms which are generated by the optical component and different in accordance with the oscillation wavelengths, so that the astigmatisms coincide with each other. Since it is possible to correct by the correcting section the astigmatisms which are different in accordance with the oscillation wavelengths, so that the astigmatisms coincide with each other, it is possible to make astigmatism for a laser beam of one oscillation wavelength coincide with astigmatisms for laser beams of the other oscillation wavelengths.

Consequently, when the focus error signal outputted from the light receiving portion that receives the laser beam of the one oscillation wavelength becomes zero, the focus error signals outputted from the light receiving portions that receive light reflected from the other optical recording mediums corresponding to the laser beams of the other oscillation wavelengths can also become zero. Therefore, it is possible to prevent occurrence of a focus offset with respect to both the one oscillation wavelength and the other oscillation wavelengths. By preventing occurrence of the focus offset, it is possible, in order to form a focal point of a beam spot of the laser beam of each of the respective oscillation wavelengths emitted from the light source on an information recording surface of the optical recording medium, to stably execute focus servo control of regulating a relative position of the objective lens to the optical recording medium and controlling a focus position of the beam spot. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, in the invention, it is preferable that the correcting section is a cylindrical lens.

According to the invention, the correcting section is a cylindrical lens, and disposed to the light receiving device. By providing the light receiving device with the cylindrical lens as the correcting section, it is possible to give astigmatism generated by the cylindrical lens to an entering laser beam of one oscillation wavelength or entering laser beams of the other oscillation wavelengths, thereby making the astigmatism for the laser beam of the one oscillation wavelength coincide with the astigmatisms for the laser beams of the other oscillation wavelengths. Consequently, when the focus error signal outputted from the light receiving portion that receives the laser beam of the one oscillation wavelength becomes zero, the focus error signals outputted from the light receiving portions that receive the light reflected from the other optical recording mediums corresponding to the laser beams of the other oscillation wavelengths can also become zero.

Therefore, it is possible to prevent occurrence of a focus offset with respect to both the one oscillation wavelength and the other oscillation wavelengths. By preventing occurrence of the focus offset, it is possible to execute the focus servo control with stability. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, in the invention, it is preferable that the correcting section includes a covering portion for covering the one light receiving portion and the other light receiving portions, and

a size in a thickness direction of a part of the covering portion covering the one light receiving portion is more than a size in a thickness direction of a part of the covering portion covering the other light receiving portions.

According to the invention, the correcting section includes a covering portion for covering the one light receiving portion and the other light receiving portions. By making a size in a thickness direction of a part of the covering portion covering the one light receiving portion more than a size in a thickness direction of a part of the covering portion covering the other light receiving portions, and making the laser beam of the one oscillation wavelength and the laser beam of the other oscillation wavelengths pass through such a covering portion as described above, it is possible to make the astigmatism for the laser beam of the one oscillation wavelength coincide with the astigmatisms for the laser beams of the other oscillation wavelengths. Consequently, when the focus error signal outputted from the one light receiving portion that receives the laser beam of the one oscillation wavelength becomes zero, the focus error signals outputted from the other light receiving portions that receive the laser beams of the other oscillation wavelengths can also become zero.

Therefore, it is possible to prevent occurrence of a focus offset with respect to both the one oscillation wavelength and the other oscillation wavelengths. By preventing occurrence of the focus offset, it is possible to execute the focus servo control with stability. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, in the invention, it is preferable that the correcting section includes one covering portion for covering the one light receiving portion and another covering portion for covering the other light receiving portions, and

a refractive index of the other covering portion is differentiated from that of the one covering portion.

Further, according to the invention, the correcting section includes the one covering portion for covering the one light receiving portion and another covering portion for covering the other light receiving portions. A refractive index of the other covering portion is differentiated from that of the one covering portion. For example, the refractive index of the one covering portion is set so as to be larger than the refractive index of the other covering portion. Then, for example, by making the laser beam of the one oscillation wavelength pass through the one covering portion whose refractive index is larger than that of the other covering portion, and making the laser beams of the other oscillation wavelengths pass through the other covering portion whose refractive index is smaller than that of the one covering portion, it is possible to make the astigmatism for the laser beam of the one oscillation wavelength coincide with the astigmatisms for the laser beams of the other oscillation wavelengths. Consequently, when the focus error signal outputted from the one light receiving portion that receives the laser beam of the one oscillation wavelength becomes zero, the focus error signals outputted from the other light receiving portions that receive the laser beams of the other oscillation wavelengths can also become zero.

Therefore, it is possible to prevent occurrence of a focus offset with respect to both the one oscillation wavelength and the other oscillation wavelengths. By preventing occurrence of the focus offset, it is possible to execute the focus servo control with stability. Therefore, it is possible to accurately execute the processing of reproducing information recorded on the optical recording medium and the processing of recording information on the optical recording medium. Consequently, it is possible to increase the reliability of an optical pickup apparatus, and it is also possible to increase the yield of an optical pickup apparatus.

Still further, the invention provides an information recording and reproducing apparatus equipped with the optical pickup apparatus.

According to the invention, it is possible to realize an information recording and reproducing apparatus equipped with the optical pickup apparatus as described before. Therefore, it is possible to realize an information recording and reproducing apparatus capable of accurately executing the processing of reproducing information recorded on the optical recording medium and the processing of recording information on the optical recording medium.

### BRIEF DESCRIPTION OF THE DRAWINGS

Other and further objects, features, and advantages of the invention will be more explicit from the following detailed description taken with reference to the drawings wherein:

FIG. 1 is a view illustrating a configuration of an optical pickup apparatus according to a first embodiment of the invention;

FIG. 2 is a view illustrating a shape of a first light receiving portion and a shape of a condensation spot of a first laser beam on the first light receiving portion;

FIG. 3 is a view illustrating a shape of a second light receiving portion and a shape of a condensation spot of a second laser beam on the second light receiving portion;

FIG. 4 is a cross section view illustrating a light receiving device in a second embodiment of the invention;

FIG. 5 is a view illustrating a shape of a first light receiving portion and a shape of a condensation spot of a first laser beam on the first light receiving portion;

FIG. 6 is a view illustrating a shape of a second light receiving portion and a shape of a condensation spot of a second laser beam on the second light receiving portion;

FIG. 7 is a cross section view illustrating a light receiving device in a third embodiment of the invention;

FIG. 8 is a cross section view illustrating a light receiving device in a fourth embodiment of the invention;

FIG. 9 is a cross section view illustrating a light receiving device in a fifth embodiment of the invention;

FIG. 10 is a block diagram illustrating a configuration of an information recording and reproducing apparatus;

FIG. 11 is a view for illustrating just-focus positions for first and second laser beams in a related art optical pickup apparatus;

FIG. 12 is a view illustrating a shape of a first light receiving portion as a component of the related art optical pickup apparatus and a shape of a condensation spot of a first laser beam on the first light receiving portion; and

FIG. 13 is a view illustrating a shape of a second light receiving portion as a component of the related art optical pickup apparatus and a shape of a condensation spot of a second laser beam on the second light receiving portion.

### DETAILED DESCRIPTION

Now referring to the drawings, preferred embodiments of the invention are described below.

A plurality of forms for embodying the invention will be described below. In the following description, parts corresponding to those described in a previous embodiment are denoted by the same reference numerals, and repetition of description may be omitted. In the case of describing only part of a configuration, the remaining part of the configuration is considered to be the same as in a previously described embodiment.

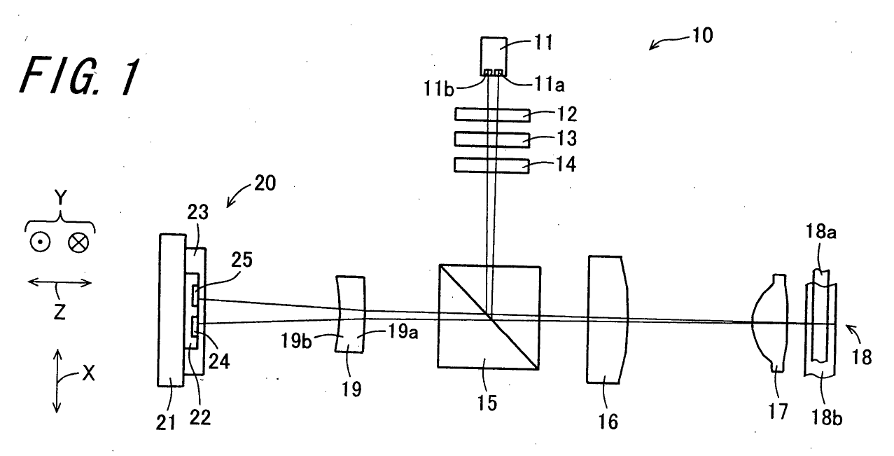

FIG. 1 is a view illustrating a configuration of an optical pickup apparatus 10 according to a first embodiment of the invention. The optical pickup apparatus 10 comprises a semiconductor laser light source portion 11, a phase-difference plate 12, a first diffraction grating 13, a second diffraction grating 14, a beam splitter 15, a collimation lens 16, an objective lens 17, a sensor lens 19, and a light receiving device 20.

The semiconductor laser light source portion 11 serving as the light source includes a first semiconductor laser device 11a and a second semiconductor laser device 11b. The first and second semiconductor laser devices 11a and 11b are provided on one surface portion of a semiconductor substrate that is not illustrated in the drawing, respectively. The first semiconductor laser device 11a emits a laser beam of one oscillation wavelength, for example, a laser beam of red wavelength of 660 nm (occasionally referred to as “first laser beam” hereinafter), and is used at the time of execution of at least one of processing of reproducing information recorded on an information recording surface of a digital versatile disk (abbreviated as DVD) 18a and processing of recording information on the information recording surface of the DVD 18a, for example. The one oscillation wavelength is not limited to 660 nm.

The second semiconductor laser device 11b emits a laser beam of the other oscillation wavelength different from the one oscillation wavelength, for example, a laser beam of infrared wavelength of 780 nm (occasionally referred to as “second laser beam” hereinafter), and is used at the time of execution of at least one of processing of reproducing information recorded on an information recording surface of a compact disk (abbreviated as CD) 18b and processing of recording information on the information recording surface of the CD 18b, for example. The other oscillation wavelength is not limited to 780 nm. Both the first and second laser beams are linearly polarized laser beams. The first and second laser beams enter the phase-difference plate 12.

The phase-difference plate 12 is realized by, for example, a quarter-wavelength plate. The phase-difference plate 12 converts linearly polarized incident light into circularly polarized light and emits, and converts circularly polarized incident light into linearly polarized light and emits. Therefore, the first and second laser beams are converted from linearly polarized laser beams into circularly polarized laser beams by the phase-difference plate 12. Then, the laser beams converted into circularly polarized light enter the first diffraction grating 13.

The first diffraction grating 13 is provided with diffraction grooves that diffract the first laser beam having an oscillation wavelength of 660 nm. The first diffraction grating 13 diffracts the first laser beam having an oscillation wavelength of 660 nm by the diffraction grooves, thereby dividing into transmitted light as one main beam and ±1st-order diffracted lights as two sub beams. The second diffraction grating 14 is provided with diffraction grooves that diffract the second laser beam having an oscillation wavelength of 780 nm. The second diffraction grating 14 diffracts the second laser beam having an oscillation wavelength of 780 nm by the diffraction grooves, thereby dividing into transmitted light as one main beam and ±1st-order diffracted lights as two sub beams.

The first diffraction grating 13 has wavelength selectivity so as not to diffract the second laser beam having an oscillation wavelength of 780 nm, and the second diffraction grating 14 has wavelength selectivity so as not to diffract the first laser beam having an oscillation wavelength of 660 nm. Therefore, the first laser beam emitted from the first semiconductor laser device 11a and entering the first diffraction grating 13 is diffracted by the first diffraction grating 13, and thereinafter, is transmitted through the second diffraction grating 14 and enters the beam splitter 15. The second laser beam emitted from the second semiconductor laser device 11b and entering the first diffraction grating 13 is transmitted through the first diffraction grating 13 and diffracted by the second diffraction grating 14, and thereinafter, enters the beam splitter 15. In the following description, the first and second laser beams may be simply referred to as “light” or “laser beams.”

The beam splitter 15 has a function of a so-called half mirror, which transmits substantially a half the light and reflects substantially a half the light. In specific, the beam splitter 15 reflects the entering laser beams emitted from the first and second semiconductor laser devices 11a and 11b and transmitted through the phase-difference plate 12 and the first and second diffraction gratings 13 and 14, in a direction to an optical recording medium 18 so as to enter the collimation lens 16. Moreover, the beam splitter 15 transmits reflection light reflected from the optical recording medium 18, in a direction to the light receiving device 20.

The collimation lens 16 converts the entering laser beams emitted from the first and second semiconductor laser devices 11a and 11b and reflected by the beam splitter 15 into parallel light and guides to the objective lens 17, and also converts the entering parallel light transmitted through the objective lens 17 into converged light and guides to the light receiving device 20.

The objective lens 17 condenses the incident light on the information recording surface of the optical recording medium 18. The objective lens 17 is configured so as to be capable of being driven by an actuator, which is not illustrated in the drawing, to move in a focus direction as an optical axis direction of the objective lens 17 and in a tracking direction as a radial direction of the optical recording medium 18, respectively. Then, the objective lens is configured so that a position of the objective lens 17 is controlled by focus servo control and tracking servo control so that a spot of the laser beam can follow a track on the optical recording medium 18.

The focus servo control is control of regulating focus positions of the beam spots of the laser beams emitted from the respective semiconductor laser devices so that focal points of the beam spots coincide with each other on the information recording surface of the optical recording medium 18. The tracking servo control is control of moving the position of the objective lens 17 of the optical pickup apparatus 10 in the radial direction of the optical recording medium 18 and regulate a positional relation between the beam spot of the laser beam emitted from each of the semiconductor laser devices and the track so that the beam spot follow the track on the information recording medium of the optical recording medium 18.

The laser beam condensed on the optical recording medium 18 is reflected from the optical recording medium 18 and enters the objective lens 17 to be changed into parallel light, and thereinafter, enters the collimation lens 16. The light reflected from the optical recording medium 18 and entering the collimation lens 16 is changed into converged light, and thereinafter, enters the beam splitter 15. The converged light entering the beam splitter 15 is transmitted through the beam splitter 15, and enters the sensor lens 19.

The sensor lens 19 serving as the optical component condenses the entering laser beam reflected from the optical recording medium 18 and transmitted through the objective lens 17, the collimation lens 16 and the beams splitter 15, on a first light receiving portion 24 or a second light receiving portion 25 of the light receiving device 20 described later. The sensor lens 19 includes a cylindrical face 19a and a concave lens face 19b. The sensor lens 19 is placed midway in an optical path that guides the light reflected from the optical recording medium 18, to the light receiving device 20, and midway in an optical path between the beam splitter 15 and the light receiving device 20. The cylindrical face 19a is formed on one surface portion closer to the beam splitter 15 of the sensor lens 19, and the concave lens face 19b is formed on one surface portion closer to the light receiving device 20 of the sensor lens 19. The sensor lens 19 provided with the cylindrical face 19a is an optical element rotationally asymmetric about an optical axis thereof, and therefore, functions as an astigmatism generating device and gives astigmatism to the entering laser beam.

The light receiving device 20 includes a base 21, a light receiving device main body portion 22 and a covering portion 23. The light receiving device main body portion 22 includes the first light receiving portion 24 and the second light receiving portion 25. The base 21 has a substantially rectangular shape. On one surface portion in a thickness direction of the base 21, the light receiving device main body portion 22 is mounted. The covering portion 23 is a member for covering the light receiving device main body portion 22 in order to avoid physical contact of the light receiving device main body portion 22 with the outside, and is a translucent member. The covering portion 23 is attached to the one surface portion in the thickness direction of the base 21 so as to cover the light receiving device main body portion 22. Consequently, the light receiving device main body portion 22 is hermetically sealed by the base 21 and the covering portion 23. In the present embodiment, the first light receiving portion 24 corresponds to the one light receiving portion, and the second light receiving portion 25 corresponds to the other light receiving portion.

In the embodiment described below, a direction parallel to one side of the base 21 is defined as an X-axis direction, and a direction parallel to the other side adjoining the one side of the base 21 is defined as a Y-axis direction. The thickness direction of the base 21, which is a direction orthogonal to the X-axis direction and the Y-axis direction, is defined as a Z-axis direction. In FIG. 1, the X-axis direction, the Y-axis direction and the Z-axis direction are expressed as “X,” “Y” and “Z,” respectively. The first light receiving portion 24 and the second light receiving portion 25 are placed apart from each other in the X-axis direction, and on the same virtual plane, which is one virtual plane parallel to an XY plane.

The first and second light receiving portions 24 and 25 are realized by, for example, photodiodes. The first light receiving portion 24 receives the first laser beam emitted from the first semiconductor laser device 11a and reflected from the DVD 18a, and converts the received first laser beam into electric signals. The second light receiving portion 25 receives the second laser beam emitted from the second semiconductor laser device 11b and reflected from the CD 18b, and converts the received second laser beam into electric signals.

The focus direction corresponds to the Z-axis direction illustrated in FIG. 1, and the tracking direction corresponds to the X-axis direction illustrated in FIG. 1.

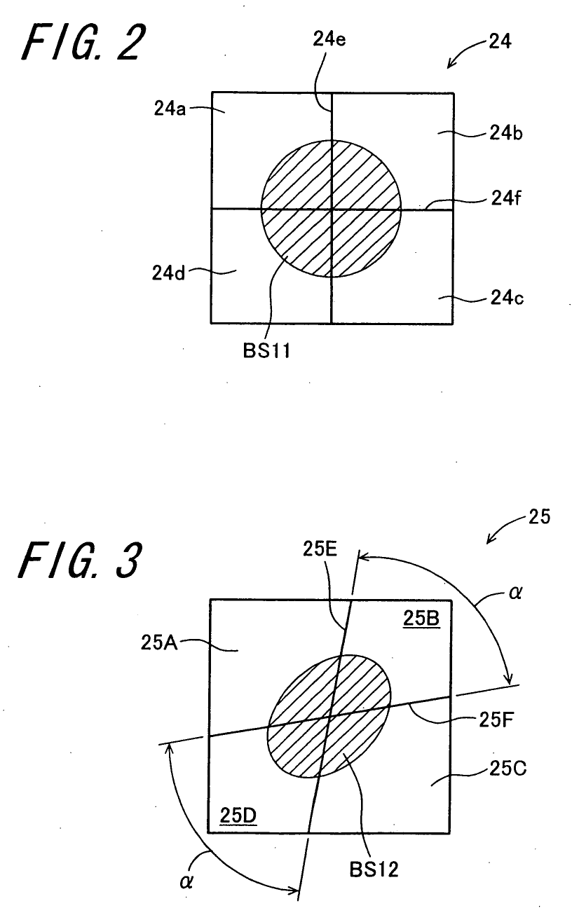

FIG. 2 is a view illustrating a shape of the first light receiving portion 24 and a shape of a condensation spot BS 11 of the first laser beam on the first light receiving portion 24. FIG. 3 is a view illustrating a shape of the second light receiving portion 25 and a shape of a condensation spot BS 12 of the second laser beam on the second light receiving portion 25. The first light receiving portion 24 has a square shape when seen from a side where the first laser beam enters. The first light receiving portion 24 is divided in four by a first dividing line 24e and a second dividing line 24f that are orthogonal to each other, thereby having four light receiving regions having square shapes, specifically, a first light receiving region 24a, a second light receiving region 24b, a third light receiving region 24c and a fourth light receiving region 24d. The first and second dividing lines 24e and 24f are straight lines.

The second light receiving portion 25 has a square shape when seen from a side where the second laser beam enters. The second light receiving portion 25 is divided in four by a first dividing line 25E and a second dividing line 25F, thereby having four light receiving regions, specifically, a first light receiving region 25A, a second light receiving region 25B, a third light receiving region 25C and a fourth light receiving region 25D. The first and second dividing lines 25E and 25F cross each other so as to divide the second light receiving portion 25 into the four light receiving regions 25A to 25D as described above. The first and second dividing lines 25E and 25F are straight lines.

In the present embodiment, in order that a focus error signal outputted from the second light receiving portion 25 becomes zero even when the second laser beam emitted from the second semiconductor laser device 11b is received, at least one of angles formed by the first dividing line 25E and the second dividing line 25F of the second light receiving portion 25 is defined so as to become an acute angle or an obtuse angle. In more specific, as illustrated in FIG. 3, angles α formed by the first dividing line 25E and the second dividing line 25F in the second and fourth light receiving regions 25B and 25D are defined so as to become acute angles of, for example, 80 degrees. However, the angle α is not limited to 80 degrees. In other words, angles formed by the first dividing line 25E and the second dividing line 25F in the first and third light receiving regions 25A and 25C are defined so as to become obtuse angles. In specific, each of the angles is defined so as to become an angle obtained by subtracting a value of the angle α from 180 degrees, in the present embodiment, so as to become 100 degrees.

The light receiving regions 24a to 24d of the first light receiving portion 24 output a focus error signal based on the received first laser beam. In the optical pickup apparatus 10 of the present embodiment, based on the focus error signal outputted from the light receiving regions 24a to 24d of the first light receiving portion 24, the focus servo control with respect to the DVD 18a is executed. The light receiving regions 25A to 25D of the second light receiving portion 25 output a focus error signal based on the received second laser beam. In the optical pickup apparatus 10 of the present embodiment, based on the focus error signal outputted from the light receiving regions 25A to 25D of the second light receiving portion 25, the focus servo control with respect to the CD 18b is executed.

In the present embodiment, when the first laser beam emitted from the first semiconductor laser device 11a is focused on the optical recording medium, a relative position of the sensor lens 19 to the first light receiving portion 24 is regulated so that a first FES becomes zero. In other words, the relative position of the sensor lens 19 to the first light receiving portion 24 is regulated so that the shape of the condensation spot BS11 of the first laser beam received by the first light receiving portion 24 becomes a circular shape as illustrated in FIG. 2. In the case of regulating the relative position of the sensor lens 19 to the first light receiving portion 24 in this manner, a focus error signal in the first light receiving portion 24 by the astigmatic method (occasionally referred to as “first FES” hereinafter) is expressed by the following expression:
First FES=(V24a+V24c)−(V24b+V24d)=0 (3)
where signals outputted from the light receiving regions 24a, 24b, 24c and 24d of the first light receiving portion 24 are V24a, V24b, V24c and V24d, respectively.

In a case where the relative position of the sensor lens 19 to the first light receiving portion 24 is regulated as described above, when the second laser beam emitted from the second semiconductor laser device 11b forms a focal point on the optical recording medium, the condensation spot BS12 does not become a circular shape like the condensation spot BS11 and becomes an elliptic shape as illustrated in FIG. 3, because astigmatisms generated by an optical system, namely, the sensor lens 19 are different in accordance with the oscillation wavelengths. Therefore, in the present embodiment, in order that a second FES also becomes zero when the optical system, mainly, the sensor lens 19 is regulated in a manner that the first FES becomes zero, an angle between the first dividing line 25E and the second dividing line 25F in the second light receiving region 25B of the second light receiving portion 25 is defined so as to become an acute angle. That is to say, an angle including the line of apsides of the ellipse of the optical spot BS12 is defined so as to become an acute angle.

Accordingly, a focus error signal in the second light receiving portion 25 by the astigmatic method (occasionally referred to as “second FES” hereinafter) is expressed by the following expression:
Second FES=(V25A+V25C)−(V25B+V25D)=0
where signals outputted from the light receiving regions 25A, 25B, 25C and 25D of the second light receiving portion 25 are V25A, V25B, V25C and V25D, respectively.

As described above, according to the present embodiment, the relative position of the sensor lens 19 to the first light receiving portion 24 is regulated so that the first FES becomes zero when a focused state is obtained on the first light receiving portion 24 corresponding to the first laser beam, and the light receiving regions of the second light receiving portion 25 are defined so that the second FES outputted from the second light receiving portion 25 that receives the light reflected from the optical recording medium corresponding to the second laser beam becomes zero. In specific, in the second light receiving portion 25 divided into the four light receiving regions by the first dividing line 25E and the second dividing line 25F, at least one of the angles formed by the first dividing line 25E and the second dividing line 25F is defined so as to become an acute angle or an obtuse angle.

Consequently, when the focus error signal outputted from the first light receiving portion 24 that receives the light reflected from the DVD 18a corresponding to the first laser beam becomes zero, the focus error signal outputted from the second light receiving portion 25 that receives the light reflected from the CD 18b corresponding to the second laser beam can also become zero. Therefore, it is possible to prevent occurrence of a focus offset with respect to both the one oscillation wavelength and the other oscillation wavelength.

By preventing occurrence of the focus offset with respect to both the oscillation wavelengths as described above, it is possible to sufficiently secure a regulation range (i.e., a regulation margin) of the focus offset and, in order that the focal points of the beam spots of the first and second laser beams emitted from the semiconductor laser light source portion 11 are formed on the information recording surface of the optical recording medium 18, it is possible to stably execute the focus servo control of regulating the relative position of the objective lens 17 to the optical recording medium 18 and controlling the focus positions of the beam spots.

Accordingly, it is possible to accurately execute the processing of reproducing information recorded on the optical recording medium 18 and the processing of recording information on the optical recording medium 18. Consequently, it is possible to increase the reliability of the optical pickup apparatus 10, and it is also possible to increase the yield of the optical pickup apparatus 10. Since it is possible to accurately execute the processing of recording information and the processing of reproducing information with a simple structure that the angle formed by the first and second dividing lines 25E and 25F is defined so as to become an acute angle or an obtuse angle, it is also possible to reduce the cost of production of the optical pickup apparatus 10.

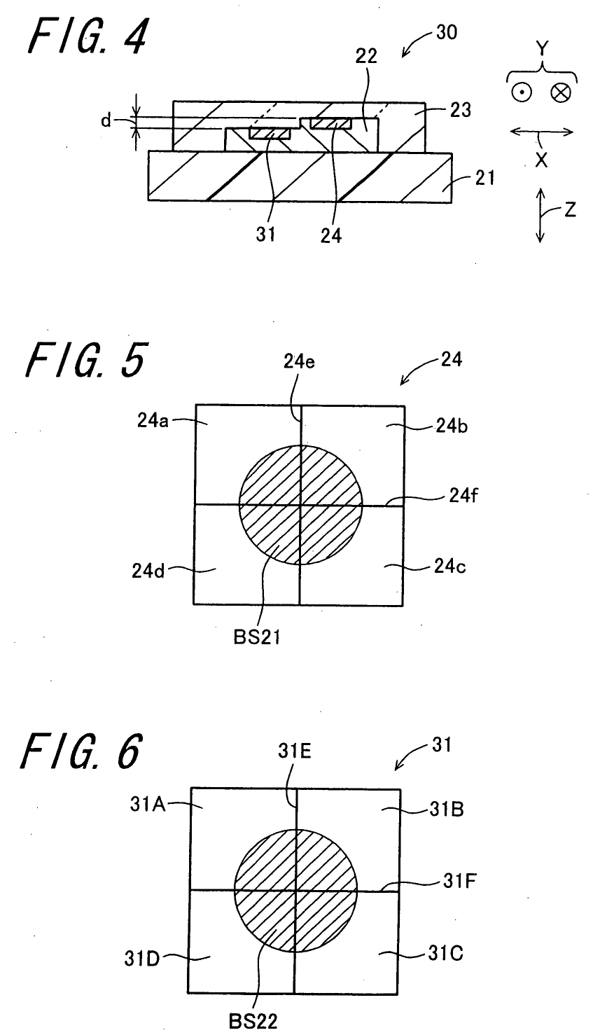

Next, the optical pickup apparatus 10 according to a second embodiment of the invention will be described. FIG. 4 is a cross section view illustrating a light receiving device 30 in the second embodiment of the invention. FIG. 5 is a view illustrating a shape of the first light receiving portion 24 and a shape of a condensation spot BS21 of the first laser beam on the first light receiving portion 24. FIG. 6 is a view illustrating a shape of a second light receiving portion 31 and a shape of a condensation spot BS22 of the second laser beam on the second light receiving portion 31. In FIG. 4, the X-axis direction, the Y-axis direction and the Z-axis direction are expressed as “X,” “Y” and “Z,” respectively. The optical pickup apparatus 10 of the present embodiment is similar to the optical pickup apparatus 10 of the aforementioned first embodiment, and only a configuration of the light receiving device is different. Therefore, a different point will be described, and description of the same point will be omitted.

The optical pickup apparatus 10 of the present embodiment comprises the light receiving device 30 instead of the light receiving device 20 of the aforementioned first embodiment. The light receiving device 30 includes the base 21, the light receiving device main body portion 22 and the covering portion 23. The light receiving device main body portion 22 includes the first light receiving portion 24 and the second light receiving portion 31. In the present embodiment, the first light receiving portion 24 corresponds to the one light receiving portion, and the second light receiving portion 31 corresponds to the other light receiving portion. The second light receiving portion 31 has the same function as the second light receiving portion 25 of the aforementioned first embodiment. The second light receiving portion 31 is different from the second light receiving portion 25 of the aforementioned first embodiment. As illustrated in FIG. 6, the second light receiving portion is divided in four by a first dividing line 31E and a second dividing line 31F that cross each other, thereby having four light receiving regions having square shapes, specifically, a first light receiving region 31A, a second light receiving region 31B, a third light receiving region 31C and a fourth light receiving region 31D. The first and second dividing lines 31E and 31F are straight lines.

In the light receiving device 30, the first light receiving portion 24 and the second light receiving portion 31 are placed apart from each other in the X-axis direction, in a manner that a distance in the Z-axis direction between the sensor lens 19 and the first light receiving portion 24 is shorter by a predetermined distance d than a distance in the Z-axis direction between the sensor lens 19 and the second light receiving portion 31. In other words, the first light receiving portion 24 and the second light receiving portion 31 are placed apart from each other by the length d in the Z-axis direction. The length d corresponds to a length between one surface portion in the Z-axis direction of the first light receiving portion 24 and one surface portion in the Z-axis direction of the second light receiving portion 31.

In more specific, in the present embodiment, the first and second light receiving portions 24 and 31 are placed so that the difference d between a distance in the Z-axis direction between the sensor lens 19 and the first light receiving portion 24 and a distance in the Z-axis direction between the sensor lens 19 and the second light receiving portion 31 becomes 0.2 mm, when a focal length of the collimation lens 16 is 15 mm, a radius of curvature of the cylindrical face 19a of the sensor lens 19 is 30 mm, a radius of curvature of the concave lens face 19b of the sensor lens 19 is 8 mm and a refractive index of the covering portion 23 of the light receiving device 30 is 1.5.

The first and second light receiving portions 24 and 31 are placed as described above, whereby when the first laser beam reflected from the optical recording medium 18, specifically, from the DVD 18a is received by the first light receiving portion 24, the shape of the condensation spot BS21 of the first laser beam becomes a circular shape as illustrated in FIG. 5, and the focus error signal in the first light receiving portion 24 by the astigmatic method becomes zero. Moreover, when the second laser beam reflected from the optical recording medium 18, specifically, from the CD 18b is received by the second light receiving portion 31, the shape of the condensation spot BS22 of the second laser beam becomes a circular shape as illustrated in FIG. 6. Therefore, the second FES that is the focus error signal in the second light receiving portion 31 by the astigmatic method is expressed by the following expression:
Second FES=(V31A+V31C)−(V31B+V31D)=0 (5)
where signals outputted from the light receiving regions 31A, 31B, 31C and 31D of the second light receiving portion 31 are V31A, V31B, V31C and V31D, respectively.

As described above, according to the present embodiment, in view of the fact that the astigmatisms generated by the cylindrical face 19a of the sensor lens 19 are different in accordance with the oscillation wavelengths, the first light receiving portion 24 and the second light receiving portion 31 are placed so that the distance in the Z-axis direction between the first light receiving portion 24 receiving the first laser beam whose oscillation wavelength is relatively short and the sensor lens 19 becomes shorter by the predetermined distance d, in the present embodiment, by 0.2 mm than the distance in the Z-axis direction between the second light receiving portion 31 receiving the second laser beam whose oscillation wavelength is longer than that of the first laser beam and the sensor lens 19.

Consequently, when the focus error signal outputted from the first light receiving portion 24 becomes zero, the focus error signal outputted from the second light receiving portion 31 can also become zero. Therefore, it is possible to prevent occurrence of the focus offset with respect to both the one oscillation wavelength and the other oscillation wavelength.

By preventing occurrence of the focus offset with respect to both the oscillation wavelengths as described above, it is possible to stably execute the focus servo control. Therefore, it is possible to accurately execute the processing of reproducing information recorded on the optical recording medium 18 and the processing of recording information on the optical recording medium 18. Consequently, it is possible to increase the reliability of the optical pickup apparatus 10, and it is also possible to increase the yield of the optical pickup apparatus 10.

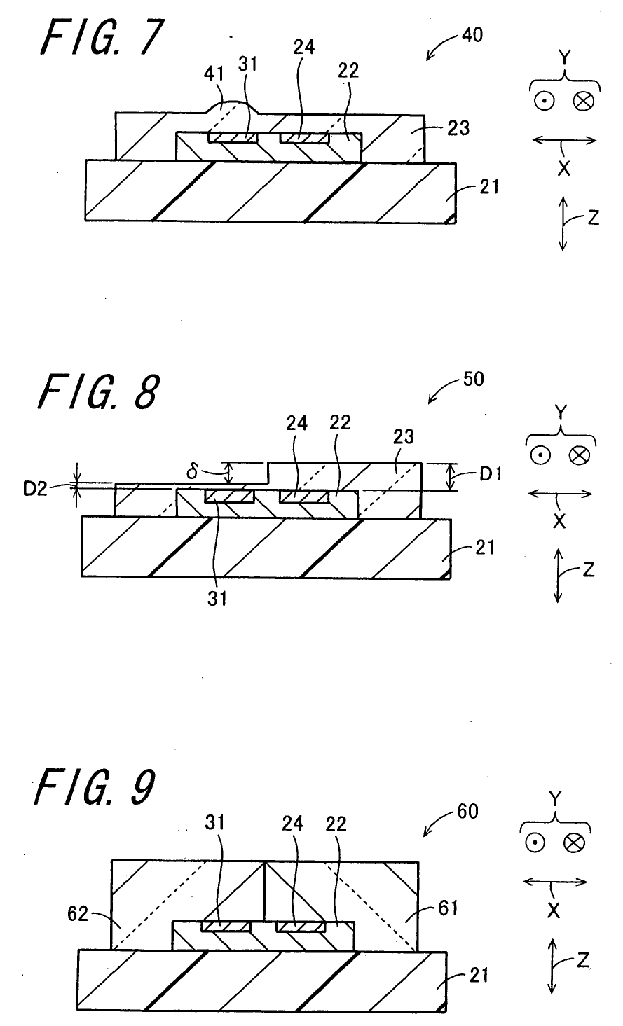

Next, the optical pickup apparatus 10 according to a third embodiment of the invention will be described. FIG. 7 is a cross section view illustrating a light receiving device 40 in the third embodiment of the invention. In FIG. 7, the X-axis direction, the Y-axis direction and the Z-axis direction are expressed as “X,” “Y” and “Z,” respectively. The optical pickup apparatus 10 of the present embodiment is similar to the optical pickup apparatus 10 of the aforementioned first embodiment, and only a configuration of the light receiving device is different. Therefore, a different point will be described, and description of the same point will be omitted.

The optical pickup apparatus 10 of the present embodiment comprises the light receiving device 40 instead of the light receiving device 20 of the aforementioned first embodiment. The light receiving device 40 includes the base 21, the light receiving device main body portion 22 and the covering portion 23. The light receiving device main body portion 22 includes the first light receiving portion 24 and the second light receiving portion 31. In the present embodiment, the first light receiving portion 24 corresponds to the one light receiving portion, and the second light receiving portion 31 corresponds to the other light receiving portion.

In the light receiving device 40, the first light receiving portion 24 and the second light receiving portion 31 are placed apart from each other in the X-axis direction, and on the same virtual plane, which is one virtual plane parallel to the XY plane, in the same manner as in the first embodiment. The covering portion 23 of the light receiving device 40 is provided with a cylindrical lens 41 that functions as a correcting section for correcting so that astigmatisms which are generated by the cylindrical face 19a of the sensor lens 19 and different in accordance with the oscillation wavelengths, so that the astigmatisms coincide with each other. In specific, the cylindrical lens 41 is formed on one surface portion in the Z-axis direction of the covering portion 23, closer to one end portion in the X-axis direction than a center portion in the X-axis direction. In more specific, the cylindrical lens 41 is formed on the covering portion 23 midway in an optical path of the second laser beam entering to be received by the second light receiving portion 31, as well as on the covering portion 23 on one side in the Z-axis direction of the light receiving portion 31.

In the present embodiment, a radius of curvature of the cylindrical lens 41 formed on the covering portion 23 is 0.4 mm, when a focal length of the collimation lens 16 is 15 mm, a radius of curvature of the cylindrical face 19a of the sensor lens 19 is 30 mm and a radius of curvature of the concave lens face 19b of the sensor lens 19 is 8 mm.

As described above, according to the present embodiment, the cylindrical lens 41 having a radius of curvature of 0.4 mm is formed on the covering portion 23 as the correcting section for correcting the astigmatisms which are generated by the sensor lens 19 and different in accordance with the oscillation wavelengths, so that the astigmatisms coincide with each other, whereby astigmatism generated by the cylindrical lens 41 is given to the second laser beam entering the cylindrical lens 41. Consequently, it is possible to make the astigmatism for the first laser beam coincide with the astigmatism for the second laser beam.

Therefore, when the first laser beam reflected from the optical recording medium 18, specifically, from the DVD 18a is received by the first light receiving portion 24, the shape of the condensation spot BS21 of the first laser beam becomes a circular shape as illustrated in FIG. 5, and the focus error signal in the first light receiving portion 24 by the astigmatic method becomes zero. Moreover, when the second laser beam reflected from the optical recording medium 18, specifically, from the CD 18b is received by the second light receiving portion 31, the shape of the condensation spot BS22 of the second laser beam becomes a circular shape as illustrated in FIG. 6, and the focus error signal in the second light receiving portion 31 by the astigmatic method becomes zero.

Thus, when the focus error signal outputted from the first light receiving portion 24 becomes zero, the focus error signal outputted from the second light receiving portion 31 can also become zero. Therefore, it is possible to prevent occurrence of the focus offset with respect to both the one oscillation wavelength and the other oscillation wavelength.

By preventing occurrence of the focus offset with respect to both the oscillation wavelengths as described above, it is possible to stably execute the focus servo control. Therefore, it is possible to accurately execute the processing of reproducing information recorded on the optical recording medium 18 and the processing of recording information on the optical recording medium 18. Consequently, it is possible to increase the reliability of the optical pickup apparatus 10, and it is also possible to increase the yield of the optical pickup apparatus 10.

Next, the optical pickup apparatus 10 according to a fourth embodiment of the invention will be described. FIG. 8 is a cross section view illustrating a light receiving device 50 in the fourth embodiment of the invention. In FIG. 8, the X-axis direction, the Y-axis direction and the Z-axis direction are expressed as “X,” “Y” and “Z,” respectively. The optical pickup apparatus 10 of the present embodiment is similar to the optical pickup apparatus 10 of the aforementioned first embodiment, and only a configuration of the light receiving device is different. Therefore, a different point will be described, and description of the same point will be omitted.

The optical pickup apparatus 10 of the present embodiment comprises the light receiving device 50 instead of the light receiving device 20 of the aforementioned first embodiment. The light receiving device 50 includes the base 21, the light receiving device main body portion 22 and the covering portion 23. The light receiving device main body portion 22 includes the first light receiving portion 24 and the second light receiving portion 31. In the present embodiment, the first light receiving portion 24 corresponds to the one light receiving portion, and the second light receiving portion 31 corresponds to the other light receiving portion. In the light receiving device 50, the first light receiving portion 24 and the second light receiving portion 31 are placed apart from each other in the X-axis direction, and on the same virtual plane, which is one virtual plane parallel to the XY plane, in the same manner as in the first embodiment.

In the present embodiment, the covering portion 23 is formed so that a size in a thickness direction of a part of the covering portion 23 covering the first light receiving portion 24 becomes larger than a size in a thickness direction of a part of the covering portion 23 covering the second light receiving portion 31. In specific, the covering portion 23 is formed so that a length D1 between one surface portion in the Z-axis direction of the first light receiving portion 24 and one surface portion in the Z-axis direction of the part of the covering portion 23 covering the first light receiving portion 24 becomes larger than a length D2 between one surface portion in the Z-axis direction of the second light receiving portion 31 and one surface portion in the Z-axis direction of the part of the covering portion 23 covering the second light receiving portion 31. A length δ between one surface portion in the Z-axis direction on the other side in the X-axis direction from the center portion in the X-axis direction of the covering portion 23 and one surface portion in the Z-axis direction on one side in the X-axis direction from the center portion in the X-axis direction of the covering portion 23 corresponds to a length of a difference between the length D1 and the length D2. In the present embodiment, the covering portion 23 of the light receiving device 50 functions as the correcting section for correcting the astigmatisms which are different in accordance with the oscillation wavelengths, so that the astigmatisms coincide with each other.

In the present embodiment, the length D1 is 0.5 mm and the length D2 is 0.1 mm, when a focal length of the collimation lens 16 is 15 mm, a radius of curvature of the cylindrical face 19a of the sensor lens 19 is 30 mm and a radius of curvature of the concave lens face 19b of the sensor lens 19 is 8 mm.

As described above, according to the present embodiment, the covering portion 23 is formed so that the length D1 between the one surface portion in the Z-axis direction of the first light receiving portion 24 and the one surface portion in the Z-axis direction of the part of the covering portion 23 covering the first light receiving portion 24 becomes larger than the length D2 between the one surface portion in the Z-axis direction of the second light receiving portion 31 and the one surface portion in the Z-axis direction of the part of the covering portion 23 covering the second light receiving portion 31, and the first and second laser beams are transmitted through the covering portion 23 as described above, whereby it is possible to make the astigmatism for the first laser beam coincide with the astigmatism for the second laser beam.

Therefore, when the first laser beam reflected from the optical recording medium 18, specifically, from the DVD 18a is received by the first light receiving portion 24, the shape of the condensation spot BS21 of the first laser beam becomes a circular shape as illustrated in FIG. 5, and the focus error signal in the first light receiving portion 24 by the astigmatic method becomes zero. Moreover, when the second laser beam reflected from the optical recording medium 18, specifically, from the CD 18b is received by the second light receiving portion 31, the shape of the condensation spot BS22 of the second laser beam becomes a circular shape as illustrated in FIG. 6, and the focus error signal in the second light receiving portion 31 by the astigmatic method becomes zero.

Thus, when the focus error signal outputted from the first light receiving portion 24 becomes zero, the focus error signal outputted from the second light receiving portion 31 can also become zero. Therefore, it is possible to prevent occurrence of the focus offset with respect to both the one oscillation wavelength and the other oscillation wavelengths.

By preventing occurrence of the focus offset with respect to both the oscillation wavelengths as described above, it is possible to stably execute the focus servo control. Therefore, it is possible to accurately execute the processing of reproducing information recorded on the optical recording medium 18 and the processing of recording information on the optical recording medium 18. Consequently, it is possible to increase the reliability of the optical pickup apparatus 10, and it is also possible to increase the yield of the optical pickup apparatus 10.

Next, the optical pickup apparatus 10 according to a fifth embodiment of the invention will be described. FIG. 9 is a cross section view illustrating a light receiving device 60 in the fifth embodiment of the invention. In FIG. 9, the X-axis direction, the Y-axis direction and the Z-axis direction are expressed as “X,” “Y” and “Z,” respectively. The optical pickup apparatus 10 of the present embodiment is similar to the optical pickup apparatus 10 of the aforementioned first embodiment, and only a configuration of the light receiving device is different. Therefore, a different point will be described, and description of the same point will be omitted.

The optical pickup apparatus 10 of the present embodiment comprises the light receiving device 60 instead of the light receiving device 20 of the aforementioned first embodiment. The light receiving device 60 includes the base 21, the light receiving device main body portion 22, a first covering portion 61 and a second covering portion 62. The light receiving device main body portion 22 includes the first light receiving portion 24 and the second light receiving portion 31. In the present embodiment, the first light receiving portion 24 corresponds to the one light receiving portion, and the second light receiving portion 31 corresponds to the other light receiving portion.

In the light receiving device 60, the first light receiving portion 24 and the second light receiving portion 31 are placed apart from each other in the X-axis direction, and on the same virtual plane, which is one virtual plane parallel to the XY plane, in the same manner as in the first embodiment. The first covering portion 61 and the second covering portion 62 are members for covering the light receiving device main body portion 22 in order to avoid physical contact of the light receiving device main body portion 22 with the outside, and are translucent members.

The first covering portion 61 is attached to one surface portion in the Z-axis direction of the base 21 so as to cover a part closer to the other side in the X-axis direction than the center portion in the X-axis direction of the light receiving device main body portion 22, more specifically, so as to cover the first light receiving portion 24. Consequently, the part closer to the other side in the X-axis direction than the center portion in the X-axis direction of the light receiving device main body portion 22 including the first light receiving portion 24 is hermetically sealed by the base 21 and the first covering portion 61.

The second covering portion 62 is attached to the one surface portion in the Z-axis direction of the base 21 so as to cover a part closer to one side in the X-axis direction than the center portion in the X-axis direction of the light receiving device main body portion 22, more specifically, so as to cover the second light receiving portion 31. Consequently, the part closer to the one side in the X-axis direction than the center portion in the X-axis direction of the light receiving device main body portion 22 including the second light receiving portion 31 is hermetically sealed by the base 21 and the second covering portion 62.

In the present embodiment, a refractive index of the first covering portion 61 and a refractive index of the second covering portion 62 are differentiated from each other. In specific, the light receiving device is configured so that the refractive index of the first covering portion 61 becomes larger than the refractive index of the second covering portion 62. In other words, as a material of the first covering portion 61, a material having a larger refractive index than a material of the second covering portion 62 is selected. In the present embodiment, the first and second covering portions 61 and 62 of the light receiving device 60 function as the correcting section for correcting the astigmatisms which are different in accordance with the oscillation wavelengths, so that the astigmatisms coincide with each other.

In the present embodiment, the refractive index of the first covering portion 61 is 1.7 and the refractive index of the second covering portion 62 is 1.5, when a focal length of the collimation lens 16 is 15 mm, a radius of curvature of the cylindrical face 19a of the sensor lens 19 is 30 mm and a radius of curvature of the concave lens face 19b of the sensor lens 19 is 8 mm.

As described above, according to the present embodiment, the light receiving device is configured so that the refractive index of the first covering portion 61 becomes larger than the refractive index of the second covering portion 62, whereby the first laser beam is made to pass through the first covering portion 61 having a relatively large refractive index and enter the first light receiving portion 24, and the second laser beam is made to pass through the second covering portion 62 having a smaller refractive index than the first covering portion 61 and enter the second light receiving portion 31. Consequently, it is possible to make the astigmatism for the first laser beam coincide with the astigmatism for the second laser beam.

Therefore, when the first laser beam reflected from the optical recording medium 18, specifically, from the DVD 18a is received by the first light receiving portion 24, the shape of the condensation spot BS21 of the first laser beam becomes a circular shape as illustrated in FIG. 5, and the focus error signal in the first light receiving portion 24 by the astigmatic method becomes zero. Moreover, when the second laser beam reflected from the optical recording medium 18, specifically, from the CD 18b is received by the second light receiving portion 31, the shape of the condensation spot BS22 of the second laser beam becomes a circular shape as illustrated in FIG. 6, and the focus error signal in the second light receiving portion 31 by the astigmatic method becomes zero.

Thus, when the focus error signal outputted from the first light receiving portion 24 becomes zero, the focus error signal outputted from the second light receiving portion 31 can also become zero. Therefore, it is possible to prevent occurrence of the focus offset with respect to both the one oscillation wavelength and the other oscillation wavelength.

By preventing occurrence of the focus offset with respect to both the oscillation wavelengths as described above, it is possible to stably execute the focus servo control. Therefore, it is possible to accurately execute the processing of reproducing information recorded on the optical recording medium 18 and the processing of recording information on the optical recording medium 18. Consequently, it is possible to increase the reliability of the optical pickup apparatus 10, and it is also possible to increase the yield of the optical pickup apparatus 10.

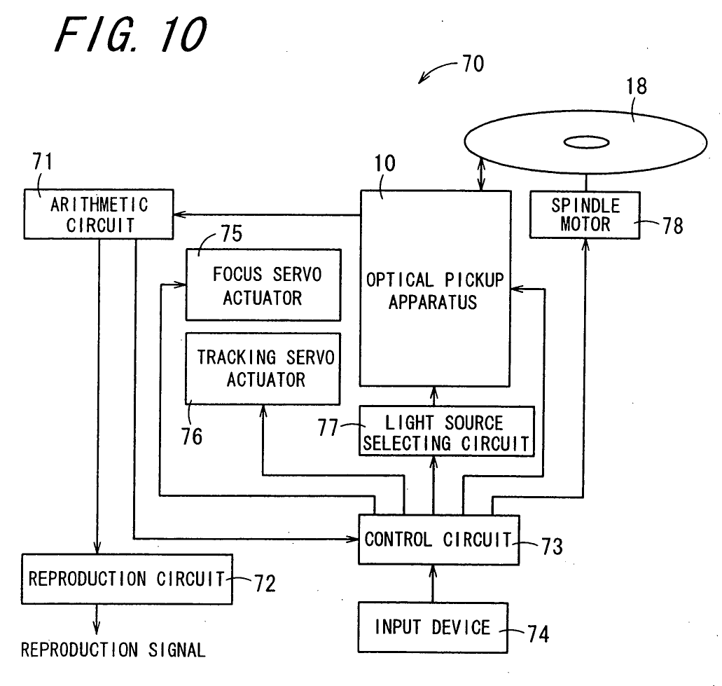

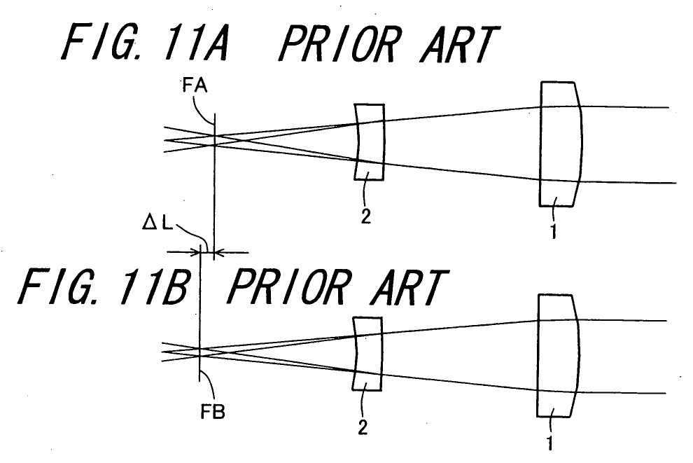

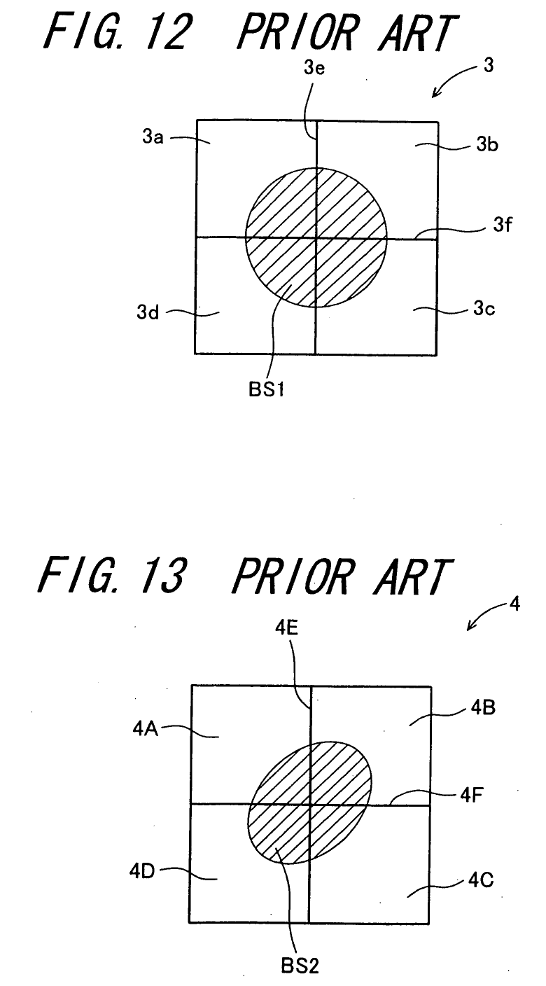

FIG. 10 is a block diagram illustrating a configuration of an information recording and reproducing apparatus 70. The information recording and reproducing apparatus 70 is capable of recording information on the optical recording medium 18 such as the DVD 18a and the CD 18b, and capable of reproducing information recorded on the optical recording medium 18. The information recording and reproducing apparatus 70 comprises the optical pickup apparatus 10, an arithmetic circuit portion 71, a reproduction circuit portion 72, a control circuit portion 73, an input device 74, a focus servo actuator 75, a tracking servo actuator 76, a light source selecting circuit portion 77, and a spindle motor 78.

In the optical pickup apparatus 10, light emitted from a light source selected by the light source selecting circuit portion 77 based on a command from the control circuit portion 73, for example, the first laser beam emitted from the first semiconductor laser device 11a passes through the phase-difference plate 12, the first diffraction grating 13, the second diffraction grating 14, the beam splitter 15, the collimation lens 16 and the objective lens 17, and is condensed on the information recording surface of the optical recording medium 18, specifically, of the DVD 18a. Then, the light reflected from the optical recording medium 18 is received by the first light receiving portion 24 of the light receiving device 60, and signals outputted from the respective light receiving regions are outputted as PD output signals to the arithmetic circuit portion 71.

The arithmetic circuit portion 71 generates data detection signals for reproducing the information recorded on the optical recording medium 18, based on the PD output signals given from the optical pickup apparatus 10, and outputs the generated data detection signals to the reproduction circuit portion 72. Moreover, the arithmetic circuit portion 71 detects a focus error signal (occasionally simply referred to as “FES” hereinafter) by the astigmatic method, and also detects a tracking error signal (occasionally simply referred to as “TES” hereinafter) by the phase-difference method or the like. Then, the arithmetic circuit portion 71 outputs the FES and the TES to the control circuit portion 73.

The reproduction circuit portion 72 equalizes the data detection signals outputted from the arithmetic circuit portion 71, and thereinafter, converts into digital signals. Then, the reproduction circuit portion demodulates the signals by error correction processing or the like, and outputs the demodulated signals as reproduction signals to an external output device such as a speaker.

Based on the FES outputted from the arithmetic circuit portion 71, the control circuit portion 73 controls the focus servo actuator 75 so as to move the objective lens 17 of the optical pickup apparatus 10 in the Z-axis direction illustrated in FIG. 1, thereby executing the focus servo control of regulating focus positions of beam spots of the laser beams so that focal points of the beam spots coincide with each other on the information recording surface of the optical recording medium 18. Moreover, based on the TES outputted from the arithmetic circuit portion 71, the control circuit portion 73 controls the tracking servo actuator 76 so as to dislocate the objective lens 17 of the optical pickup apparatus 10 in the radial direction of the optical recording medium 18, namely, in the X-axis direction in FIG. 1, thereby executing the tracking servo control of regulating a positional relation between the beam spot of the laser beam and the track on the information recording surface of the optical recording medium 18 so that the beam spot follows the track.

Further, based on a command inputted by the input device 74, the control circuit portion 73 controls the light source selecting circuit portion 77, thereby causing the first semiconductor laser device 11a to emit the first laser beam in the case of reproducing information recorded on the DVD 18a, and causing the second semiconductor laser device to emit the second laser beam in the case of reproducing information recorded on the CD 18b. Also, the control circuit portion controls the spindle motor 78 so as to rotate the DVD 18a and CD 18b at a specified speed.

The information recording and reproducing apparatus 70 is equipped with the optical pickup apparatus 10 according to each of the aforementioned embodiments, whereby it is possible to realize the information recording and reproducing apparatus 70 that is capable of accurately executing the processing of reproducing information recorded on the optical recording medium 18 and the processing of recording information on the optical recording medium 18.

The respective embodiments described above are merely exemplifications of the invention, and the configurations thereof can be changed within the scope of the invention. Having described the configuration of the optical pickup apparatus 10 comprising the semiconductor laser light source portion 11 including the first semiconductor laser device 11a and the second semiconductor laser device 11b as the light source emitting laser beams of a plurality of oscillation wavelengths in the respective embodiments described above, the configuration is not limited to the above one. In another embodiment of the invention, the optical pickup apparatus may comprise three or more semiconductor laser devices that emit laser beams of different oscillation wavelengths, respectively, and it is possible to suitably carry out in the same manner as in the aforementioned embodiments.

Having described the optical pickup apparatus 10 comprising the sensor lens 19 as the optical component generating astigmatism in the respective embodiments described above, the optical component is not limited to the sensor lens 19. In another embodiment of the invention, the optical component may be a cylindrical lens, or a parallel plate placed inclined to an optical axis. Even when the optical pickup apparatus comprises the cylindrical lens, the parallel plate or the like as the optical component that generates astigmatism, it is possible to obtain the same effect as in the respective embodiments described above.

Although the first and second dividing lines 24e and 24f of the first light receiving portion 24, the first and second dividing lines 25E and 25F of the second light receiving portion 25, and the first and second dividing lines 31E and 31F of the second light receiving portion 31 in the respective embodiments described above are straight lines, the dividing lines may be curved lines in another embodiment of the invention.

In the aforementioned third embodiment, the cylindrical lens 41 is formed on the one surface portion in the Z-axis direction of the covering portion 23, only in a position closer to the one end portion in the X-axis direction than the center portion in the X-axis direction. However, in another embodiment of the invention, in addition to the cylindrical lens 41, another cylindrical lens having a different radius of curvature from that of the cylindrical lens 41 may be formed on the one surface portion in the Z-axis direction of the covering portion 23, in a position closer to the other end portion in the X-axis direction than the center portion in the X-axis direction. Also in this case, it is possible to obtain the same effect as in the aforementioned third embodiment.

An embodiment is not limited to those specifically described before, and it is also possible to partly combine the aforementioned embodiments in another embodiment of the invention as far as the combination does not have any problem. Also in this case, it is possible to suitably carry out in the same manner as in the respective embodiments described before.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup apparatus that detects a focus error signal by an astigmatic method, the optical pickup apparatus comprising:
a light source for emitting laser beams of a plurality of oscillation wavelengths;
a light receiving device having a plurality of light receiving portions that receive laser beams of a plurality of oscillation wavelengths emitted from the light source, the light receiving portions each having a plurality of light receiving regions, and being capable of outputting a focus error signal based on the laser beams received by the plurality of light receiving regions; and
an optical component placed midway in an optical path between the light source and the light receiving device, for generating an astigmatism,
wherein a relative position of the optical component is regulated so that a focused state is obtained on one light receiving portion corresponding to a laser beam of one oscillation wavelength among the light receiving portions corresponding to the laser beams of the plurality of oscillation wavelengths, and
the light receiving regions of each of the other light receiving portions are defined so that the focus error signals outputted from the other light receiving portions corresponding to the other laser beams of the other oscillation wavelengths become zero.

2. The optical pickup apparatus of claim 1, wherein the plurality of light receiving regions of the other light receiving portions are formed by dividing the other light receiving portions by a first dividing line and a second dividing line, and at least one of angles formed by the first dividing line and the second dividing line is defined so as to become an acute angle or an obtuse angle.

3. An optical pickup apparatus that detects a focus error signal by an astigmatic method, the optical pickup apparatus comprising:
a light source for emitting laser beams of a plurality of oscillation wavelengths;
a light receiving device having a plurality of light receiving portions that receive laser beams of a plurality of oscillation wavelengths emitted from the light source, the light receiving portions each being capable of outputting a focus error signal based on the received laser beam; and
an optical component placed midway in an optical path between the light source and the light receiving device, for generating an astigmatism,
wherein relative positions of the plurality of light receiving portions to the optical component are defined so that when a focus error signal outputted from one light receiving portion corresponding to a laser beam of one oscillation wavelength becomes zero, focus error signals outputted from the other light receiving portions corresponding to laser beams of the other oscillation wavelengths become zero.

4. The optical pickup apparatus of claim 3, wherein the optical component is placed midway in an optical path that guides light reflected from an optical recording medium, to the light receiving device, and
the one light receiving portion and the other light receiving portions are placed so that a distance between the optical component and the one light receiving portion becomes shorter than distances between the optical component and the other light receiving portions, in case where the one oscillation wavelength is shorter than the other oscillation wavelengths.

5. An optical pickup apparatus that detects a focus error signal by an astigmatic method, the optical pickup apparatus comprising:
a light source for emitting laser beams of a plurality of oscillation wavelengths;
a light receiving device having a plurality of light receiving portions that receive laser beams of a plurality of oscillation wavelengths emitted from the light source, the light receiving portions each being capable of outputting a focus error signal based on the received laser beam; and
an optical component placed midway in an optical path between the light source and the light receiving device, for generating an astigmatism,
wherein the light receiving device is provided with a correcting section for correcting astigmatisms which are generated by the optical component and different in accordance with the oscillation wavelengths, so that the astigmatisms coincide with each other.

6. The optical pickup apparatus of claim 5, wherein the correcting section is a cylindrical lens.

7. The optical pickup apparatus of claim 5, wherein the correcting section includes a covering portion for covering the one light receiving portion and the other light receiving portions, and
a size in a thickness direction of a part of the covering portion covering the one light receiving portion is more than a size in a thickness direction of a part of the covering portion covering the other light receiving portions.

8. The optical pickup apparatus of claim 5, wherein the correcting section includes one covering portion for covering the one light receiving portion and another covering portion for covering the other light receiving portions, and
a refractive index of the other covering portion is differentiated from that of the one covering portion.

9. An information recording and reproducing apparatus equipped with the optical pickup apparatus of claim 1.

10. An information recording and reproducing apparatus equipped with the optical pickup apparatus of claim 3.

11. An information recording and reproducing apparatus equipped with the optical pickup apparatus of claim 5.
